(19) United States
(12) Patent Application Publication
(10) Pub. No.: US 2014/0176686 A1
(43) Pub. Date: Jun. 26, 2014

(54) IMAGE PROCESSING DEVICE, IMAGE CAPTURING APPARATUS, AND METHOD FOR ADJUSTING DISPARITY AMOUNT

(71) Applicant: FUJIFILM Corporation, Tokyo (JP)

(72) Inventor: Satoru WAKABAYASHI, Saitama-shi (JP)

(73) Assignee: FUJIFILM Corporation, Tokyo (JP)

(21) Appl. No.: 14/191,602

(22) Filed: Feb. 27, 2014

Related U.S. Application Data
(63) Continuation of application No. PCT/JP2012/074353, filed on Sep. 24, 2012.

(30) Foreign Application Priority Data
Sep. 29, 2011 (JP) 2011-214198

(51) Int. Cl. H04N 13/04

(52) U.S. Cl. CPC H04N 13/0402
USPC 348/51

(57) ABSTRACT

A subject whose disparity amount is to be adjusted is selected with a cross key. An identification mark representing the subject is displayed on a two-dimensional graph in an assistance window. Both the disparity amount corresponding to a vertical axis and distance information corresponding to a horizontal axis are explicitly indicated. A guide mark is displayed close to the identification mark. The guide mark, being an arrow, indicates a direction in which the disparity amount of the subject decreases. The identification mark and the guide mark are shifted along the vertical axis in accordance with an operation for adjusting the disparity amount, and displayed. A disparity amount adjustment circuit is activated to adjust the disparity amount of the subject. When the identification mark is shifted to a position between displayed lines, which indicate an appropriate range, the guide mark disappears.

### BACKGROUND OF THE INVENTION

1. Field of the Invention

The present invention relates to an image processing device, an image capturing apparatus, and a method for adjusting a disparity amount of a stereoscopic image, for allowing adjustment of a disparity amount of a stereoscopic image, with quantitative understanding.

2. Description Related to the Prior Art

Two imaging systems capture two respective images of the same subject from different directions. The two viewpoint images thus obtained allow stereoscopy of the subject. A parallel method and a crossing method are known as easy ways to perform naked-eye stereoscopy. In the parallel method, the two viewpoint images which are arranged side by side are observed from parallel left and right viewpoints. In the crossing method, the left and right viewpoints are crossed to observe the viewpoint images. An anaglyphic method, a polarized glasses method, and the like are also widely known as techniques for the stereoscopy. In the anaglyphic method, two viewpoint images tinted red and blue are observed through glasses with lenses indifferent colors, red and blue. In the polarized glasses method, two viewpoint images with different polarization directions are observed with polarized glasses with lenses in different polarization directions.

Furthermore, a parallax barrier method and a lenticular method make the stereoscopy possible. In the parallax barrier method and the lenticular method, two viewpoint images are divided into thin rectangular pieces in a vertical direction and arranged alternately in a horizontal direction. In the parallax barrier method, the images are observed through a parallax barrier in which vertically-oriented slit openings are arranged at a predetermined pitch. In the lenticular method, the images are observed through a lenticular lens sheet. A method for displaying two viewpoint images alternately on a monitor and observing the image through glasses with lenses each incorporating a shutter is in practical use. Each shutter opens and closes at a period of switching the images. A method for alternately displaying two viewpoint images which have been subjected to polarization modulating processing and observing the image through glasses with lenses each incorporating a filter is in practical use. The filters have different polarizing axes.

In a case where the stereoscopy is performed using the above-described methods, a suitable stereoscopic effect differs according to a user. The stereoscopic effect varies in accordance with a shift amount (disparity amount) between two or more viewpoint images. A technique for processing image data in accordance with a disparity amount specified by a user in producing a stereoscopic image from the viewpoint images is suggested (see Japanese Patent Laid-Open Publication No. 2004-129186). A technique for adjusting the stereoscopic effect while observing a stereoscopic image produced from two or more viewpoint images is also suggested (see Japanese Patent Laid-Open Publication No. 10-90814).

The methods disclosed in the Japanese Patent Laid-Open Publication Nos. 2004-129186 and No. 10-90814 allow adjustment of a disparity amount during the observation of a stereoscopic image. In those methods, the stereoscopic effect of the displayed image itself is adjusted intuitively. The methods have a disadvantage that a change in the disparity amount cannot be grasped quantitatively.

### SUMMARY OF THE INVENTION

An object of the present invention is to provide an image processing device, an image capturing apparatus, and a method for adjusting a disparity amount, for allowing adjustment of a disparity amount of any chosen subject while the disparity amount is quantitatively checked in changing a stereoscopic effect of a stereoscopic image.

The image processing device of the present invention comprises a parallax image obtaining section for obtaining a parallax image for reproducing a stereoscopic image, a parallax information obtaining section for obtaining a disparity amount of a subject in the parallax image, a stereoscopic image display section for displaying the reproduced stereoscopic image, a subject selector, a disparity amount adjustment section, and a disparity amount graph display section. The subject selector selects specific one of the subjects displayed on the stereoscopic image display section, in accordance with a selecting operation, and provides a selection mark on a display position of the specific subject. The disparity amount adjustment section adjusts the disparity amount of the selected specific subject in accordance with an adjustment operation. The disparity amount graph display section moves an identification mark assigned to the selected subject along a disparity amount axis on a two-dimensional graph in accordance with the adjustment operation of the disparity amount adjustment section and displays the identification mark, and separately displays the identification mark and an identification mark corresponding to another subject relative to a distance information axis on the two-dimensional graph, in accordance with a relative distance in a depth direction. The relative distance in the depth direction is calculated in accordance with the disparity amount of the each subject. The two-dimensional graph is displayed on an assistance screen different from the display screen. The two-dimensional graph is represented by the disparity amount axis and the distance information axis.

It is preferable that the disparity amount graph display section displays an appropriate range of the disparity amount on the two-dimensional graph. Furthermore, it is preferable that disparity amount graph display section has a function to display a guide display on the two-dimensional graph in a case where the disparity amount of the selected subject after the adjustment is out of the appropriate range. The guide display indicates a direction of adjustment to make the disparity amount small. It is preferable that the subject selector has a function to automatically select the subject with the smallest disparity amount obtained by the disparity information obtaining section, until the selecting operation is performed. It is preferable that the disparity amount adjustment section has a function to automatically adjust the disparity amount of the selected subject to a predetermined amount after the subject selector selects the subject and before the adjustment operation of the disparity amount is performed.

In a case where the new subject is selected by the subject selector, the last selected subject is processed as the specific subject in a similar manner. The selection mark is provided to the new specific subject. On the assistance screen, the disparity amount and distance information in the depth direction between the subjects are displayed on the two-dimensional graph based on a coordinate position of the identification mark associated with the last selected subject. It is preferable to conspicuously display the identification mark of the newly selected subject on the two-dimensional graph when the selection of the subject is updated.

It is possible to display the assistance screen on a part of the display screen in the stereoscopic image display section. Note that, in a case where the parallax image is composed of an L viewpoint image and an R viewpoint image, a disparity amount between the L and R viewpoint images can be adjusted by adjusting relative positions of the L viewpoint image and the R viewpoint image in a left-right direction at the time of image composition of the L and R viewpoint images.

An image capturing apparatus of the present invention comprises a parallax image obtaining section, a parallax information obtaining section, a stereoscopic image display section, a subject selector, a disparity amount adjustment section, a disparity amount graph display section. The parallax image obtaining section captures an L viewpoint image and an R viewpoint image to obtain a parallax image. The parallax information obtaining section obtains a disparity amount of a subject in the parallax image. The stereoscopic image display section displays a stereoscopic image of the subject on a display screen, based on the parallax image. The subject selector selects specific one of the subjects displayed on the display screen, in accordance with a selecting operation, and provides a selection mark to the specific subject. The disparity amount adjustment section increases and decreases the disparity amount of the specific subject in accordance with an adjustment operation. The disparity amount graph display section moves an identification mark corresponding to the specific subject along a disparity amount axis on a two-dimensional graph in accordance with an adjustment amount of the disparity amount adjustment section and displays the identification mark, and separately displays the identification mark and an identification mark corresponding to another subject relative to a distance information axis on the two-dimensional graph, in accordance with a relative distance in a depth direction. The relative distance in the depth direction is calculated in accordance with the disparity amount of the each subject. The two-dimensional graph is displayed on an assistance screen different from the display screen. The two-dimensional graph is represented by the disparity amount axis and the distance information axis.

A method for adjusting a disparity amount of the present invention comprises a parallax image obtaining step, a parallax information obtaining step, a stereoscopic image displaying step, a selected subject displaying step, an assistance displaying step, and a display updating step. In the parallax image obtaining step, a parallax image for reproducing a stereoscopic image is obtained. In the parallax information obtaining step, a disparity amount of a subject in the parallax image is obtained based on the obtained parallax image. In the stereoscopic image displaying step, the stereoscopic image of the subject is displayed on a display screen, based on the parallax image. In the selected subject displaying step, a selection mark is provided to the specific subject to distinguish the specific subject from another subject in a case where the specific one of the displayed subjects is selected in accordance with a selecting operation. In the assistance displaying step, a relative distance in a depth direction between the specific subject and another subject is calculated based on the disparity amount of the each subject, and identification marks representing the respective subjects are displayed at positions on the two-dimensional graph. The positions represent a distance between the respective subjects. In the display updating step, a display state of the subject in the stereoscopic image displaying step and a display state of the two-dimensional graph in the assistance displaying step are updated in accordance with adjustment of the disparity amount in a case where the disparity amount of the selected subject is adjusted in accordance with an adjustment operation.

According to the present invention, a specific subject is selected as desired from the subjects displayed in the stereoscopic image display section. The disparity amount of the selected subject is adjusted. When the operation for adjusting the disparity amount is performed, an identification mark representing the specific subject is shifted on the two-dimensional graph in the assistance screen, in accordance with an amount of the adjustment, and displayed. Also, the distance information in the depth direction between the subjects is calculated based on the disparity amounts of the respective subjects on the screen and displayed in two-dimensions on the assistance screen. The disparity amount of the selected subject is changed quantitatively while distance feeling between the subjects is recognized. Thereby the adjustment operation is performed easily.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a perspective view illustrating an appearance of a 3D camera of the present invention;

FIG. 2 is a perspective view illustrating an appearance of the 3D camera from the back side;

FIG. 3 is a block diagram illustrating electrical configuration of the 3D camera;

FIG. 4A is an explanatory view of an example of a parallax image captured;

FIG. 4B is an explanatory view illustrating an example of an L viewpoint image;

FIG. 4C is an explanatory view illustrating an example of an R viewpoint image;

FIG. 5 is an explanatory view illustrating an example of a display screen of a 3D display device;

FIG. 6 is an explanatory view illustrating an example of a display on an assistance window;

FIG. 7 is a flowchart illustrating a disparity amount adjustment;

FIG. 8 is an explanatory view illustrating the assistance window displayed during the disparity amount adjustment; and

FIG. 9 is an explanatory view illustrating the assistance window at the completion of the disparity amount adjustment.

### DESCRIPTION OF THE PREFERRED EMBODIMENTS

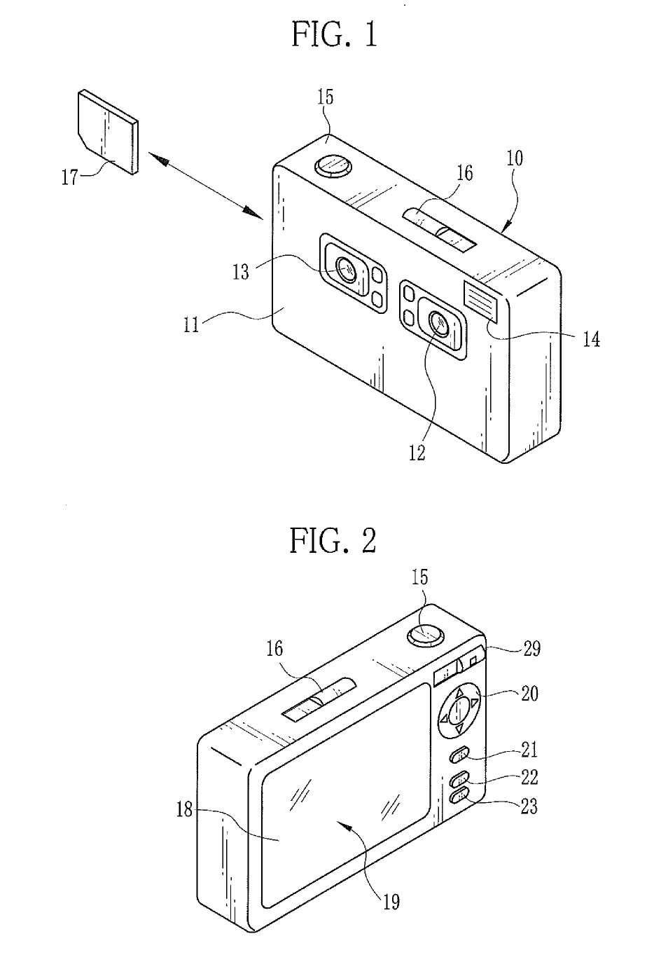

As shown in FIG. 1, an image capturing apparatus (hereinafter referred to as the 3D camera) 10 according to the present invention has a substantially rectangular parallelepiped camera body 11. A lens 12 for capturing an L viewpoint image, a lens 13 for capturing an R viewpoint image, and a flash emitter 14 are provided on a front surface of the camera body 11. A shutter release button 15 and a power button 16 are provided on a top face of the camera body 11. A slot (not shown) is provided on a right-grip side surface of the camera body 11. A memory card 17 for storing image data is inserted into the slot in a detachable manner. The image data obtained by image capture is recorded and stored in the memory card 17.

As shown in FIG. 2, a 3D display device 18 is provided on the back surface of the camera body 11. The 3D display device 18 allows stereoscopic observation of a subject image. The 3D display device 18 is a stereoscopic image display section for stereoscopically displaying a reproduced image read out from the memory card 17, live view images (through images), or the like. Various methods such as a lenticular method, a disparity barrier method, a parallax barrier method, anaglyphic method, a frame-sequential method, and a light direction method may be used for displaying stereoscopic images. In this embodiment, the 3D display device 18 which employs the lenticular method is used.

In the lenticular method, for example, data processing is performed based on a pair of L and R viewpoint image data captured with the 3D camera 10. As a result of the data processing, a plurality of virtual viewpoint image data with slightly different viewpoints in a left-right direction are generated from the pair of the L and R viewpoint image data. Thin rectangular viewpoint images are produced from the respective virtual viewpoint image data thus generated. The viewpoint images are displayed at a predetermined pitch on an LCD panel of the 3D display device 18. The viewpoint images are observed as a stereoscopic image, through a lenticular lens sheet integrated into a front surface of the LCD panel.

Furthermore, an imaging and reproduction mode selection button 29 for choosing an imaging mode or a reproduction mode, a cross key 20 which functions as a subject selector, a disparity adjustment mode setting button 21 for choosing one of automatic adjustment of the disparity amount, manual adjustment of the disparity amount, and turning off the adjustment of the disparity amount, and a “+” button 22 and a “−” button 23 for increasing and decreasing the disparity amount in the manual adjustment are provided on the back surface of the camera body 11.

The cross key 20 is operated to choose an item when a menu is displayed on a display screen 19 of the 3D display device 18. The cross key 20 is also used as the subject selector for performing input operation to a subject selection circuit 67 in choosing a subject, being a target of disparity amount adjustment, from the subjects displayed on the display screen 19. The “+” button 22 and the “−” button 23 are used as the buttons for increasing and decreasing values of various imaging conditions and initial settings. The “+” button 22 and the “−” button 23 are also used as input sections for a disparity amount adjustment section, to increase and decrease the disparity amount of the selected subject.

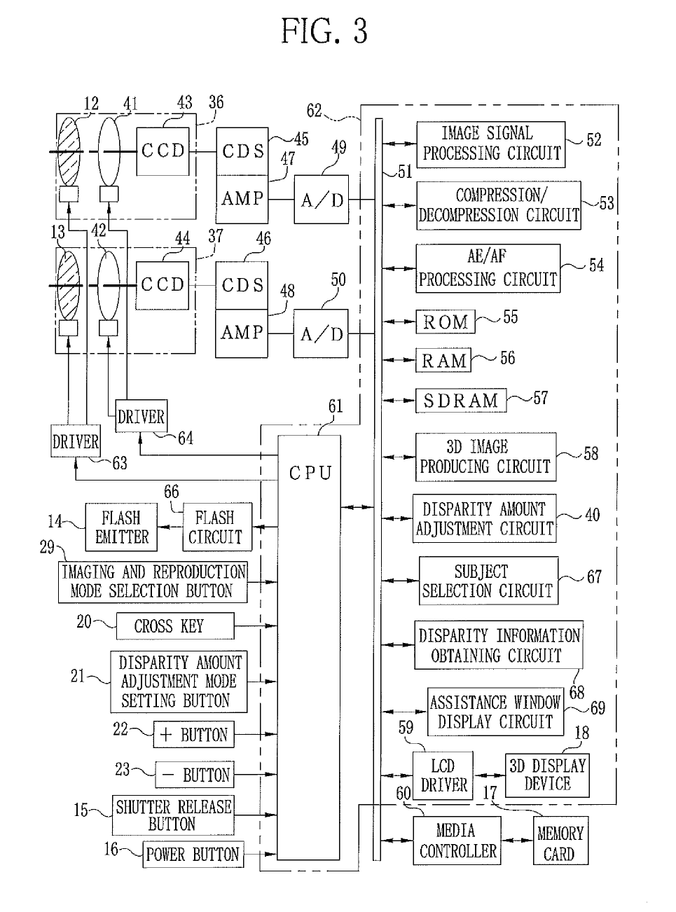

In FIG. 3, which illustrates electrical configuration of the 3D camera 10, a left viewpoint camera 36 and a right viewpoint camera 37 are provided. The left viewpoint camera 36 comprises the lens 12, a shutter 41, and an image sensor 43, for capturing an L viewpoint image. The right viewpoint camera 37 comprises the lens 13, a shutter 42, and an image sensor 44, for capturing an R viewpoint image. CCD-type image sensors (hereinafter, the CCDs) are used as the image sensors 43 and 44. Image sensors of another type, for example, MOS-type image sensors may be used as the image sensors 43 and 44.

The image signals from the CCDs 43 and 44 are inputted to a data bus 51 through CDS circuits 45 and 46, amplifiers 47 and 48, and A/D converters 49 and 50. Note that the left and right viewpoint cameras 36 and 37 correspond to a parallax image obtaining section in a case where a new parallax image is captured. In a case where parallax image data recorded in the memory card 17 is read out to reproduce a stereoscopic image, a media controller 60 corresponds to the parallax image obtaining section.

A plurality of circuits and the like which constitute the media controller 60, a CPU 61, and an image processing device 62 are connected to the data bus 51. Furthermore, an image signal processing circuit 52, a compression/decompression circuit 53, an AE/AF processing circuit 54, a ROM 55, a RAM 56, an SDRAM 57, a 3D image producing circuit 58, a disparity amount adjustment circuit 40, the subject selection circuit 67, a disparity information obtaining circuit 68, an assistance window display circuit 69, and an LCD driver 59 for controlling the LCD panel of the 3D display device 18 are connected to the data bus 51, and constitute the image processing device 62, along with the CPU 61. The CPU 61 reads out a sequence program, which is stored in the ROM 55, to the RAM 56, being the working memory, and executes it.

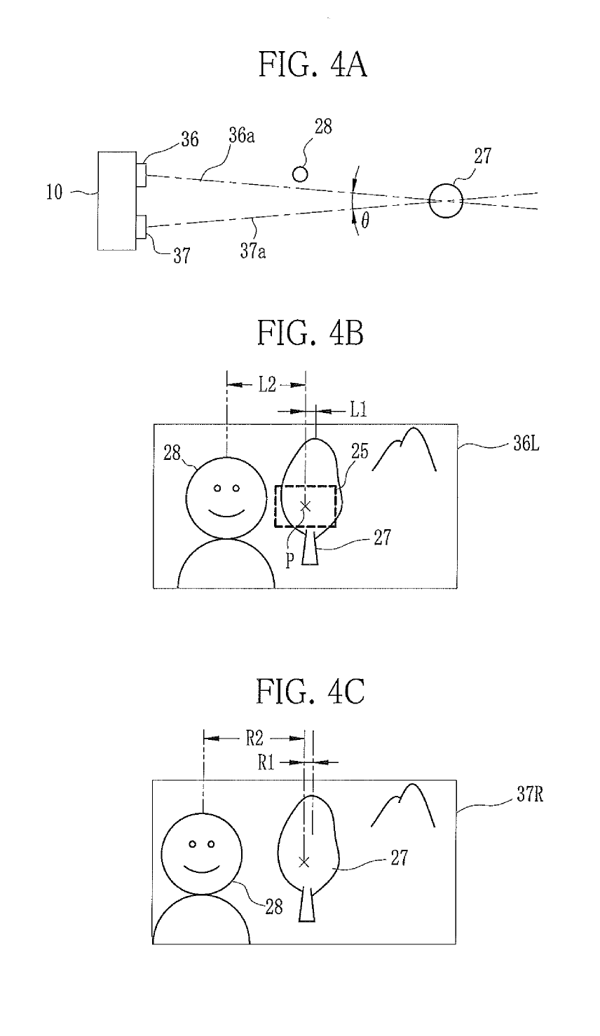

In FIG. 4A, which illustrates the state of capturing a parallax image with the left viewpoint camera 36 and the right viewpoint camera 37, optical axes 36a and 37a of the respective cameras cross each other at a convergence angle θ at a position, for example, 5 m away from the camera body 11. The subjects close to the position at which the optical axes cross each other are captured with substantially no disparity from each other in the image. Note that the optical axes 36a and 37a may not necessarily cross each other at a predetermined distance. The optical axes 36a and 37a may be parallel to each other if data processing for calculating the disparity amount is adaptable.

An L viewpoint image 36L illustrated in FIG. 4B and an R viewpoint image 37R illustrated in FIG. 4C are obtained by image capture of a tree subject 27 and a human subject 28 arranged as illustrated in the drawings, with the use of the left viewpoint camera 36 and the right viewpoint camera 37. A character P indicates the center of each screen. A character 25 indicates an AF (autofocus) area. The L viewpoint image 36L and the R viewpoint image 37R thus captured are converted into pieces of image data, respectively. The image signal processing circuit 52 performs various image processes such as tone conversion and gamma correction processing on each image data and then each image data is recorded in the SDRAM 57.

The pieces of image data are read out from the SDRAM 57 and subjected to data processing in the disparity information obtaining circuit 68. Thereby disparity amounts of the respective subjects 27 and 28 are calculated. In the L viewpoint image 36L, the tree subject 27 has a disparity L1 relative to the center P of the screen. The human subject 28 has a disparity L2 relative to the center P of the screen. In the R viewpoint image 37R, the tree subject 27 has a disparity R1 relative to the center P of the screen. The human subject 28 has a disparity R2 relative to the center P of the screen. In the L viewpoint image 36L, a disparity in a direction from the center P of the screen to the left is a negative disparity. A disparity in a direction from the center P of the screen to the right is a positive disparity. In the R viewpoint image 37R, a disparity from the center P of the screen to the right is a negative disparity. A disparity from the center P of the screen to the left is a positive disparity. In a case where the disparity amounts of the respective subjects 27 and 28 are compared with each other with respect to the parallax image composed of the L viewpoint image 36L and the R viewpoint image 37R, a disparity amount of the tree subject 27 is “+L1−R1”. A disparity amount of the human subject 28 is “−L2+R2”. The disparity amount of the tree subject 27 is substantially “0”. The human subject 28 has the positive disparity amount.

The 3D image producing circuit 58 generates pieces of virtual multi-viewpoint image data that are further subdivided in the left-right direction, based on the L viewpoint image data and the R viewpoint image data recorded in the SDRAM 57. The multi-viewpoint image data form viewpoint images which are observed as interpolations when a viewpoint position is shifted during the observation. The multi-viewpoint image data allows smooth display of a stereoscopic image. In the above-described data processing, the disparity information obtaining circuit 68, being the disparity information obtaining section, executes a logic operation process. Thereby the disparity information obtaining circuit 68 calculates the left and right disparity amounts for each subject and calculates information such as data of a difference in disparity amount between the subjects, based on the L and R viewpoint image data.

A vertically-oriented rectangular parallax image is reproduced from each multi-viewpoint image data thus generated. The each multi-viewpoint image data is inputted as an analog-converted display signal to the LCD panel of the 3D display device 18 from the LCD driver 59. Thereby a plurality of vertically-oriented rectangular parallax images are displayed at a predetermined pitch on the LCDS panel. These multi-viewpoint images are observed through a lenticular lens sheet in which extra-fine vertically-oriented cylindrical lenses are arranged at a predetermined pitch in a horizontal direction. Thereby a stereoscopic image is viewed on the display screen 19 of the 3D display device 18.

Image signals are outputted sequentially at a predetermined frame rate from each of the left viewpoint camera 36 and the right viewpoint camera 37. Every time the image signals are outputted, the above-described L viewpoint image data and R viewpoint image data are rewritten in the SDRAM 57. Every time the L viewpoint image data and the R viewpoint image data are rewritten, the disparity information obtaining circuit 68 obtains the disparity information of each subject, the 3D image producing circuit 58 performs a process for generating the multi-viewpoint image data, and a new parallax image produced from the multi-viewpoint image data is displayed. Thereby the 3D display device 18 stereoscopically displays the live view images.

The compression/decompression circuit 53 is activated to store image data of the parallax image captured with the 3D camera 10. When the shutter release button 15 is pressed to perform a recording operation of the parallax image, the compression/decompression circuit 53 performs image compression of a predetermined compression format (for example, JPEG format) on the L viewpoint image data and the R viewpoint image data, which are obtained from the image signals outputted from the left viewpoint camera 36 and the right viewpoint camera 37 immediately after the recording operation. The data-compressed L viewpoint image data and the data-compressed R viewpoint image data, along with their mutually associated information, are recorded and stored in the memory card 17 through the media controller 60

The AE/AF processing circuit 54 automatically performs exposure amount adjustment and focus adjustment, based on the image data obtained from each of the left viewpoint camera 36 and the right viewpoint camera 37. The focus adjustment is performed on a subject in the AF area 25, which is provided in a center portion of a screen. Whether the subject is in focus or out of focus is determined by the AE/AF processing circuit 54. In a case where the subject is out of focus, the CPU 61 transmits a focus adjustment command to a driver 63. Thereby the focus adjustments of the lenses 12 and 13 are performed.

The driver 63 and a driver 64 are connected to the CPU 61 and thereby commands from the CPU 61 control the focus adjustments and zooming of the lenses 12 and 13 and a stepping motor (not shown) for opening and closing the shutters 41 and 42. Furthermore, a flash circuit 66 is connected to the CPU 61. The CPU 61 performs emission control of the flash emitter 14. An operation signal from each of the shutter release button 15, the power button 16, the cross key 20, the disparity amount adjustment mode setting button 21, the “+” button 22, and the “−” button 23 is inputted to the CPU 61. The disparity amount adjustment mode setting button 21, the “+” button 22, and the “−” button 23 allow the adjustment of the disparity amount. In response to each operation signal, the CPU 61 operates the each corresponding section.

The imaging and reproduction mode selection button 29 is used for choosing whether to use the 3D camera 10 as the image capturing apparatus or a reproducing apparatus. In a case where the use of the 3D camera 10 as the image capturing apparatus is chosen, the image data of the L viewpoint image captured with the left viewpoint camera 36 and the image data of the R viewpoint image captured with the right viewpoint camera 37 are recorded as described above. The recordings are performed when the shutter release button 15 is operated. Until the shutter release button 15 is operated, the 3D display device 18 allows the observation of the live view images displayed in 3D. In a reproduction mode, the observation of a stereoscopic image based on the parallax image data, which is read out from an internal memory of the 3D camera 10 or the memory card 17, is allowed.

The disparity amount adjustment mode setting button 21 is operated to choose one of an automatic adjustment mode and a manual adjustment mode. In the automatic adjustment mode, the disparity amount is automatically adjusted when a subject, being a target of the disparity amount adjustment, is selected from the subjects displayed in the display screen 19 of the 3D display device 18. In the manual adjustment mode, the disparity amount is adjusted as necessary after the subject, being the target of the disparity amount adjustment, is selected. Note that, when the disparity amount adjustment mode setting button 21 is not operated, the adjustment of the disparity amount is in an OFF state, and the subject, being the target of the focus adjustment, in the autofocus area is processed as the subject with zero disparity. With each pressing operation of the disparity amount adjustment mode setting button 21, the mode is set to “the automatic adjustment mode”, “the manual adjustment mode” or “off” in this order.

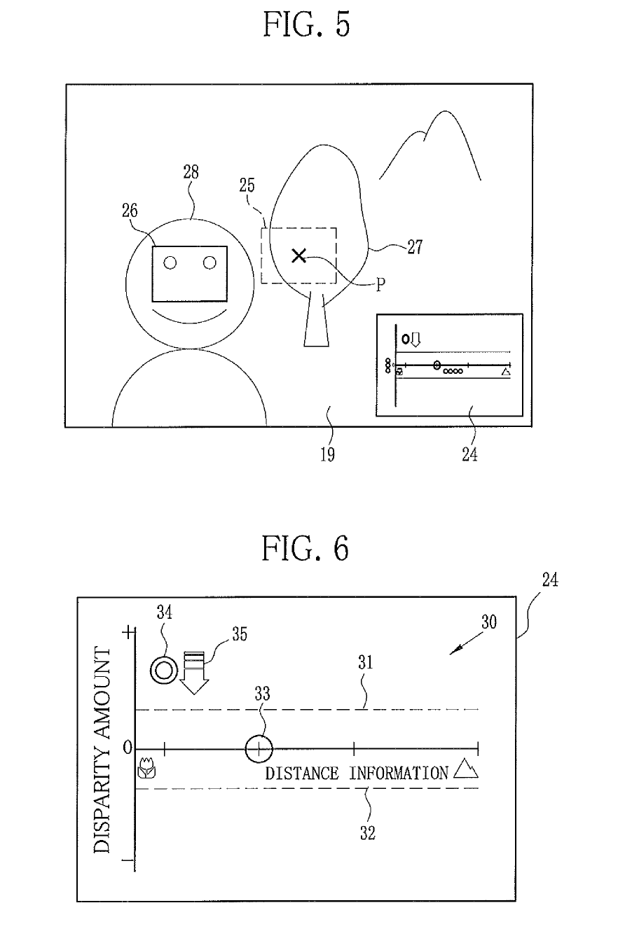

Hereinafter, the operation of the above configuration is described. When the normal live view images are displayed, an assistance window 24 is not displayed on the display screen 19 of the 3D display device 18 illustrated in FIG. 5. For example, the entire display screen 19 is used for displaying a stereoscopic image. As illustrated in the drawing, the AF area 25 is set in the center portion of the screen in which the screen center P is included, so that the focus adjustment is performed on the tree subject 27. An initial position of a frame mark 26 that is a selection mark for choosing a subject, being the target of the disparity amount adjustment, overlaps the AF area 25. In this case, an image of the tree subject 27 is captured with the disparity amount “0”.

In this live view image, a stereoscopic image of the human subject 28 is stereoscopically displayed as if the human subject 28 is situated in front of the tree subject 27. The tree subject 27 with the zero disparity amount is displayed on the display screen 19 relative to the depth direction, so that the tree subject 27 hardly moves when a viewpoint position slightly moves in a left-right direction during the observation. The human subject 28 is likely to move considerably in the left-right direction when the viewpoint moves, because the human subject 28 is displayed as if the human subject 28 is situated above the display screen 19. In a case where the human subject 28 is a main subject, it is extremely difficult to observe it.

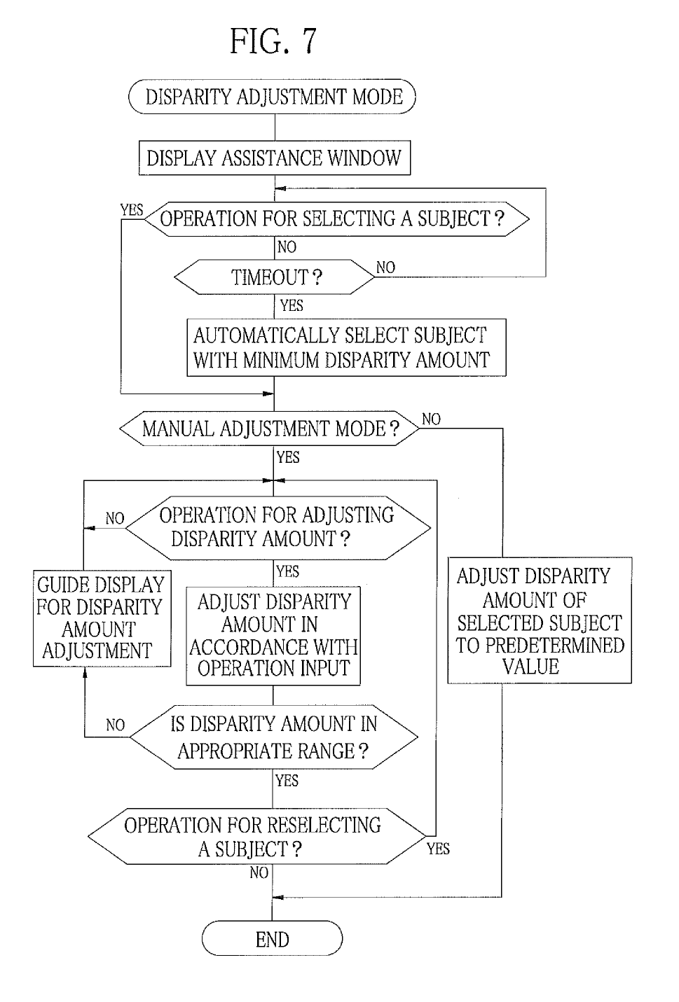

In order to reduce the disparity amount of the human subject 28 to facilitate the observation, the disparity amount adjustment mode setting button 21 is operated to switch to the disparity amount adjustment mode as illustrated in a flowchart in FIG. 7. Concurrently with the switching operation, the assistance window display circuit 69 is activated. Thereby the assistance window 24, being a disparity amount graph display section, appears in a lower right area of the display screen 19. In a display area of the assistance window 24, a single viewpoint image for displaying a two-dimensional graph is displayed instead of a parallax image for displaying stereoscopic live view images. The two-dimensionally displayed graph is observed through the lenticular lens sheet of the 3D display device 18.

As shown in FIG. 6, displayed lines 31 and 32 are displayed on a two-dimensional graph 30 on the assistance window 24. The displayed lines 31 and 32 indicate upper and lower limits of an appropriate disparity amount range. A horizontal axis (distance information axis) that represents the disparity amount “0” is positioned between the displayed lines 31 and 32. The 3D camera 10 identifies the tree subject 27 and the human subject 28 as the subjects within a finite subject distance range. Identification marks 33 and 34, which represent the subjects 27 and 28, are displayed separately at the respective coordinate positions along the distance information axis in accordance with the respective subject distances.

Here, the identification mark 33 that represents the tree subject 27 has the disparity amount “0”, so that the identification mark 33 is displayed on the horizontal axis. The identification mark 34 that represents the human subject 27 is displayed on a position with a disparity amount in the positive direction. Note that, as for a display position in the depth direction of the display screen 19, the surface of the display screen 19 corresponds to the disparity amount “0”. The subject with a positive disparity amount is observed as if the subject is suspended over the surface in accordance with the degree of the positive disparity amount. The subject with a negative disparity amount is observed as if the subject is situated at the rear of the surface in accordance with the degree of the negative disparity amount.

As shown in FIG. 6, the identification mark 33 representing the tree subject 27 is displayed at the position corresponding to the disparity amount “0”. The identification mark 34 representing the human subject 28 is displayed above the displayed line 31, indicating that the disparity amount in the positive direction is too high and not suitable for the stereoscopic observation. A guide mark 35 is displayed on the side of the identification mark 34. The guide mark 35 prompts revising the disparity amount downward.

The automatic adjustment mode is selected by pressing the disparity amount adjustment mode setting button 21 once. After the mode is switched to the automatic adjustment mode, the cross key 20 is operated to move the frame mark 26 from the AF area 25 and place the frame mark 26 on a desired subject on the display screen 19. Thus the subject is selected. The focus adjustment is performed on the tree subject 27 in the AF area 25 on the display screen 19 illustrated in FIG. 5. The tree subject 27 has the smallest disparity amount among the subjects on the display screen 19.

The subject with the smallest disparity amount is automatically selected as the target of the disparity amount adjustment when the operation for choosing a subject is not performed after a predetermined lapse of time after switching to the disparity amount adjustment mode. Thereby the identification mark 33 blinks to be displayed conspicuously as compared with other identification marks. The disparity amount of the tree subject 27 is automatically set to the predetermined disparity amount “0”. Hence, actually, the disparity amount is not adjusted. The display of the live view images previously displayed is continued. Note that the automatically-set disparity amount is not necessarily “0”. For example, a disparity amount for making the subject seemingly suspended over the surface of the display screen 19 by approximately 0.5% of a length of the display screen 19 in the horizontal direction may be set as a standard.

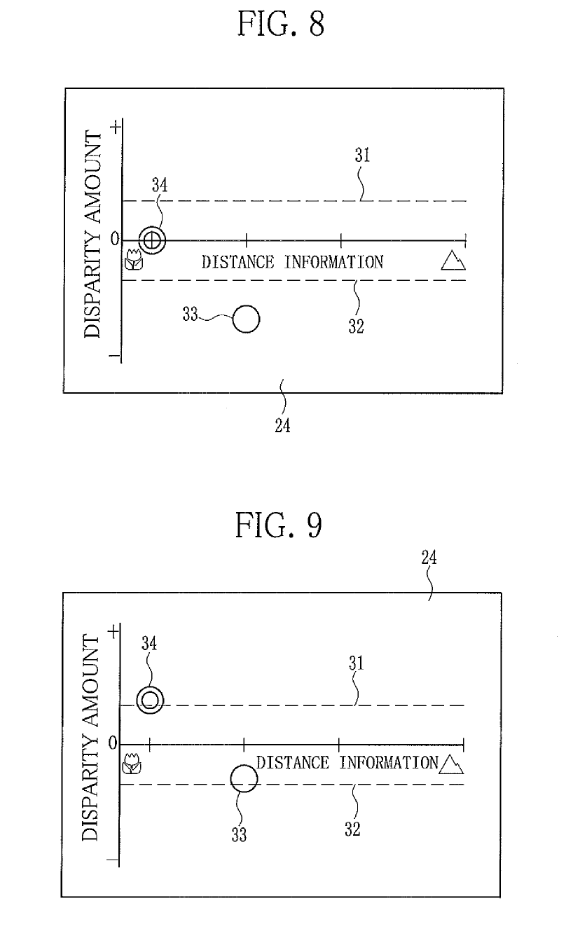

By placing the frame mark 26 on the human subject 28 before a timeout, the human subject 28 is selected as the target of the disparity amount adjustment and the identification mark 34 blinks to be conspicuous. In the automatic adjustment mode, the disparity amount adjustment circuit 40 automatically adjusts the positive disparity amount of the human subject 28 to the disparity amount “0”. At the same time, the disparity amount adjustment circuit 40 adjusts the disparity amount “0” of the tree subject 27 to a negative disparity amount. As a result, the assistance window 24 changes from the display state illustrated in FIG. 6 to the display state illustrated in FIG. 8. The identification mark 34 moves to a position corresponding to the disparity amount “0”. The identification mark 33 is moved and displayed in an area corresponding to the negative disparity amount.

Note that the subject distance of the human subject 28 is not the same as that of the tree subject 27. An adjustment amount for the disparity amount of the human subject 28 normally differs from an adjustment amount for the disparity amount of the tree subject 27. The respective pieces of subject distance information are calculated based on the disparity information which is obtained by the disparity information obtaining circuit 68 through data processing during the image capture of the live view images. In accordance with a relative disparity amount between the human subject 28 and the tree subject 27 or a difference between the relative subject distances of the human subject 28 and the tree subject 27, one of the disparity amounts is automatically adjusted while the other is adjusted by the disparity amount adjustment circuit 40.

After taking in the adjusted disparity amount information and performing data processing for making the disparity amount of the human subject 28 “0” on the L and R viewpoint image data read out from the SDRAM 57, the 3D image producing circuit 58 generates the multi-viewpoint image data. The 3D display device 18 displays the parallax image based on the adjusted multi-viewpoint image data. Thereby the live view image is stereoscopically displayed as if the human subject 28 is situated on the display surface in the depth direction. As a result, it becomes easy to observe the human subject 28. However, the disparity amount of the tree subject 27 in far view increases in the negative direction, so that it becomes difficult to stereoscopically observe the tree subject 27 with both eyes. In this case, the manual adjustment mode for manually adjusting the disparity amount is effectively used.

In the flowchart shown in FIG. 7, in the manual adjustment mode, the identification mark 34 displayed in the assistance window 24, shown in FIG. 6, blinks to await input of the disparity amount adjustment operation for the human subject 28 selected as the target of the disparity amount adjustment. The identification mark 33 of the tree subject 27 is displayed at the position corresponding to the disparity amount “0”. The identification mark 34 of the human subject 28 is out of an appropriate disparity amount range in the positive direction, so that the guide mark 35 in the direction of decreasing the disparity amount is displayed on the side of the identification mark 34.

Each time the “−” button 23 is pressed in accordance with the instruction of the guide mark 35, the identification mark 34 moves downward. The identification mark 33 also moves downward. At the same time, the disparity amount adjustment circuit 40 adjusts the disparity amount in accordance with the pressing operation of the “−” button 23. The subject distance of the tree subject 27 is greater than that of the human subject 28, so that a moving amount of the identification mark 33 is generally smaller than that of the identification mark 34. The guide mark 35 disappears when the identification mark 34, being the target of the disparity amount adjustment, moves to a position which overlaps the displayed line 31 as illustrated in FIG. 9, notifying that the disparity amount of the human subject 28 is within the appropriate range.

In the state in which the two-dimensional graph 30 shown in FIG. 9 is displayed in the assistance window 24, the disparity amount of the human subject 28 and the disparity amount of the tree subject 27 are within the appropriate range of the disparity amount. When the display screen 19 of the 3D display device 18 is observed, the human subject 28 is displayed as if the human subject 28 is observed slightly above the display surface. The tree subject 27 is displayed as if the tree subject 27 is observed at the rear of the display surface. The 3D image producing circuit 58 generates the multi-viewpoint image data based on data of the disparity amount adjustment and displays the parallax image on the 3D display device 18. Thereby the human subject 28 and the tree subject 27 are observed with appropriate stereoscopic effect in the depth direction.

In order to readjust the disparity amount of the tree subject 27, the cross key 20 is operated to place the frame mark 26 on the tree subject 27 again. Thereby the identification mark 33 of the tree subject 27 blinks on the assistance window 24 illustrated in FIG. 9. The disparity amount adjustment circuit 40 is operated in response to the operation of the “+” button 22 and the “−” button 23. Thus the disparity amount of the tree subject 27 is adjusted. Note that the disparity amount of the human subject 28 is adjusted concurrently with the disparity amount adjustment of the tree subject 27. In the assistance window 24, the identification mark 34 is also moved in the same direction as that of the identification mark 33, with a different moving amount.

In a case where a third subject, other than the tree subject 27 and the human subject 28, is included in the parallax image, the third subject is also displayed on the display screen 19. It is also possible to select the third subject as a target of the disparity amount adjustment. The disparity information obtaining circuit 68 obtains disparity amount information and subject distance information of the third subject, so that an identification mark which represents the third subject is also displayed on the assistance window 24. The assistance window 24 is displayed at the time the mode is switched to the disparity amount adjustment mode. After that, the disparity amount is adjusted in a similar manner.

In a case where the parallax image is captured by operating the shutter release button 15 after the adjustment of the disparity amount, image data of non-adjusted L and R viewpoint images is stored in the SDRAM 57. By recording the data of the disparity amount adjustment as metadata with the image data, a stereoscopic image with the adjusted disparity amounts is observed in the same manner as the above at the time of the reproduction. The above-described processes are also applicable to the case in which the data is recorded in the external memory card 17.

In the above embodiments, the inputted L and R viewpoint images are stored without the adjustments. The parallax image with the adjusted disparity amount is obtained by image data processing of the L and R viewpoint images. The convergence angle θ between the left viewpoint camera 36 and the right viewpoint camera 37 may be adjusted. The disparity amount adjustment may be performed using the adjustment of the convergence angle θ or in consideration of the adjustment of the convergence angle θ. A touch panel laminated on the surface of the 3D display device 18 may be used as an input device for selecting a subject or increasing or decreasing the disparity amount. Touch operation, drag operation, and shift operation with a finger tip or a touch pen may be performed.

The assistance window 24 may be provided as an independent display section separately from the display screen 19 of the 3D display device 18. In order to conspicuously display the subject selected as the target of the disparity amount adjustment, a color of the identification mark may be changed, instead of blinking the identification mark as described in the embodiments. The degree of the disparity amount adjustment is analog-displayed using a shift length of the identification mark. Instead, a digital display may be possible by providing in the order of ±5 levels with respect to a reference point “0” in a practically appropriate disparity amount range. Note that the two-dimensional graph is not limited to the display illustrated in the drawing as long as two axis, a disparity amount axis and the distance information axis, are used.

Furthermore, it is possible to keep the subject with the disparity amount “0” in focus with priority during imaging, as long as the L viewpoint image is captured with the left viewpoint camera 36 and the R viewpoint image is captured with the right viewpoint camera 37 as described in the above embodiments. As for an image capturing apparatus with a face image detection function, face images are automatically searched in a subject image and the frame mark is shifted from one face image to another in ascending order of the subject distance. A selected one of the face images is automatically set as the target of the disparity amount adjustment. This example is also effective in implementing the present invention. In a case where the selected subject is in a far distance or out of depth of field, a warning may be displayed on the display screen 19.

In the above-described embodiments, the L viewpoint image is captured with the left viewpoint camera 36 and the R viewpoint image is captured with the right viewpoint camera 37. The present invention is also applicable to an image processing device for reading each viewpoint image from the memory card 17 to display a stereoscopic image, as with the above-described image processing device. The present invention can be implemented as a method for adjusting a disparity amount which is effectively employed in the above embodiments.

Various changes and modifications are possible in the present invention and may be understood to be within the present invention.

What is claimed is:

1. An image processing device comprising:
a parallax image obtaining section for obtaining a parallax image for reproducing a stereoscopic image;
a parallax information obtaining section for obtaining a disparity amount of a subject in the parallax image;
a stereoscopic image display section for displaying the stereoscopic image of the subject on a display screen, based on the parallax image;
a subject selector for selecting specific one of the subjects displayed on the display screen, in accordance with a selecting operation, and providing a selection mark to the specific subject;
a disparity amount adjustment section for increasing and decreasing the disparity amount of the specific subject in accordance with an adjustment operation; and
a disparity amount graph display section for moving an identification mark corresponding to the specific subject along a disparity amount axis on a two-dimensional graph in accordance with the adjustment operation of the disparity amount adjustment section and displaying the identification mark, and separately displaying the identification mark and an identification mark corresponding to the another subject relative to a distance information axis on the two-dimensional graph in accordance with a relative distance in a depth direction, the relative distance in the depth direction being calculated in accordance with the disparity amount of the each subject, the two-dimensional graph being displayed on an assistance screen different from the display screen, the two-dimensional graph being represented by the disparity amount axis and the distance information axis.

2. The image processing device of claim 1, wherein the disparity amount graph display section displays an appropriate range of the disparity amount on the two-dimensional graph.

3. The image processing device of claim 2, wherein the disparity amount graph display section displays a guide display on the two-dimensional graph in a case where the disparity amount of the selected subject after the adjustment is out of the appropriate range, and the guide display indicates a direction for adjusting the disparity amount toward the appropriate range.

4. The image processing device of claim 1, wherein the subject selector automatically selects the subject with the smallest disparity amount obtained by the disparity information obtaining section, until the selecting operation is performed.

5. The image processing device of claim 4, wherein the disparity amount adjustment section automatically adjusts the disparity amount of the selected subject to a predetermined amount in response to the selection of the subject selected using the subject selector.

6. The image processing device of claim 1, wherein the selection mark is shifted to the last selected subject and displayed and the identification mark representing the last selected subject is displayed in a distinguishable manner from the another identification mark in the disparity amount graph display section in a case where the new subject is selected using the subject selector.

7. The image processing device of claim 1, wherein the disparity amount adjustment section changes relative positions of an L viewpoint image and an R viewpoint image in a left-right direction at the time of image composition of the L and R viewpoint images, to adjust the disparity amount of the parallax image.

8. The image processing device of claim 1, wherein a part of the display screen in the stereoscopic image display section is used for the assistance screen of the disparity amount graph display section.

9. An image capturing apparatus comprising:
a parallax image obtaining section for capturing an L viewpoint image and an R viewpoint image to obtain a parallax image;
a parallax information obtaining section for obtaining a disparity amount of a subject in the parallax image;
a stereoscopic image display section for displaying a stereoscopic image of the subject on a display screen, based on the parallax image;
a subject selector for selecting specific one of the subjects displayed on the display screen, in accordance with a selecting operation, and providing a selection mark to the specific subject;
a disparity amount adjustment section for increasing and decreasing the disparity amount of the specific subject in accordance with an adjustment operation; and
a disparity amount graph display section for moving an identification mark corresponding to the specific subject along a disparity amount axis on a two-dimensional graph in accordance with an adjustment amount of the disparity amount adjustment section and displaying the identification mark, and separately displaying the identification mark and an identification mark corresponding to the another subject relative to a distance information axis on the two-dimensional graph in accordance with a relative distance in a depth direction, the relative distance in the depth direction being calculated in accordance with the disparity amount of the each subject, the two-dimensional graph being displayed on an assistance screen different from the display screen, the two-dimensional graph being represented by the disparity amount axis and the distance information axis.

10. A method for adjusting a disparity amount comprising the steps of:
(A) obtaining a parallax image for reproducing a stereoscopic image;
(B) obtaining a disparity amount of a subject in the parallax image, based on the obtained parallax image;
(C) displaying the stereoscopic image of the subject on a display screen, based on the parallax image;
(D) providing a selection mark to the specific subject to distinguish the specific subject from the another subject in a case where the specific one of the displayed subjects is selected in accordance with a selecting operation;
(E) calculating a relative distance in a depth direction between the specific subject and the another subject, based on the disparity amount of the each subject, and displaying identification marks representing the respective subjects at positions on a two-dimensional graph, the positions representing a distance between the subjects; and
(F) updating a display state of the subject in the step (C) and a display state of the two-dimensional graph in the step (E) in accordance with adjustment of the disparity amount in a case where the disparity amount of the selected subject is adjusted in accordance with an adjustment operation.
